(19) United States
(12) Patent Application Publication
(10) Pub. No.: US 2025/0100396 A1
(43) Pub. Date: Mar. 27, 2025

(54) METHOD FOR OPERATING A HYBRID BATTERY TROLLEY VEHICLE, AND HYBRID BATTERY TROLLEY VEHICLE

(71) Applicant: Kiepe Electric GmbH, Düsseldorf (DE)

(72) Inventors: Sebastian Walzel, Unna (DE); Marcel Manheller, Bergheim (DE)

(21) Appl. No.: 18/841,328

(22) PCT Filed: Feb. 8, 2023
(86) PCT No.: PCT/EP2023/053090

§ 371 Date: Aug. 23, 2024

(30) Foreign Application Priority Data
Feb. 22, 2022 (DE) 10 2022 104 099.2

(51) Int. Cl. B60L 50/53; B60L 3/00; B60L 3/04

(52) U.S. Cl. CPC B60L 50/53; B60L 3/0069; B60L 3/04; B60L 2210/10; B60L 2260/26

(57) ABSTRACT

The present invention relates to a method for operating a hybrid battery trolley vehicle (1) which has an ungrounded vehicle chassis (2), an vehicle electrical system (3), an overhead line current collector (4), a DC/DC converter (5) and a battery storage (6), the hybrid battery trolley vehicle (1) being switched between an overhead line mode, in which the vehicle electrical system (3) is supplied with energy via the overhead line current collector (4) and the DC/DC converter (5), and a battery mode, in which the vehicle electrical system (3) is supplied with energy via the battery storage (6), and wherein when switching from battery mode to overhead line mode, the DC/DC converter (5) is electrically connected to the vehicle chassis (2) to reduce the output voltages of the DC/DC converter (5) present on the vehicle electrical system (3), and a hybrid battery trolley vehicle (1).

The present invention relates to a method for operating a hybrid battery trolley vehicle which comprises an ungrounded vehicle chassis, a vehicle electrical system, an overhead line current collector, a DC/DC converter and a battery storage, wherein the hybrid battery trolley vehicle is switched between an overhead line mode, in which the vehicle electrical system is supplied with energy via the overhead line current collector and the DC/DC converter, and a battery mode, in which the vehicle electrical system is supplied with energy via the battery storage. A further object of the invention is a hybrid battery trolley vehicle with an ungrounded vehicle chassis, a vehicle electrical system, an overhead line current collector and a DC/DC converter for supplying energy to the vehicle electrical system in an overhead line mode and a battery storage for supplying energy to the vehicle electrical system in a battery mode.

In the case of electric trolley vehicles supplied with energy via an overhead line, such as trolleybuses, a battery storage can be integrated into the vehicle to increase the range, in particular for travelling on sections of the route without an overhead line. These vehicles are referred to as hybrid battery trolley vehicles, which are in particular buses for local transport.

Unlike rail-bound vehicles with a chassis grounded via the rails, hybrid battery trolley vehicles have an ungrounded vehicle chassis, for example due to rubber tyres, in which there is no electrical contact between the vehicle chassis and the road surface during normal operation. Their vehicle electrical system, which comprises one or more electrical consumers and other electrical components, therefore utilises the potential of the vehicle chassis as a reference ground.

A hybrid battery trolley vehicle can be operated in two modes, overhead line mode and battery mode. In order to change the type of energy supply of the hybrid battery trolley vehicle, it is possible to switch between overhead line mode and battery mode, i.e. it is possible to switch from overhead line mode to battery mode and from battery mode to overhead line mode.

In overhead line mode, the vehicle electrical system is supplied with energy from the overhead line of an overhead line network. In order to be connected to the overhead line to receive the energy, the hybrid battery trolley vehicle has overhead line current collectors, in particular two. These can be brought into contact with the overhead line in order to establish an electrical connection with it. The energy picked up by the overhead line current collectors is passed on to a DC/DC converter of the hybrid battery trolley vehicle. This DC/DC converter converts the DC/DC of the overhead line on its primary side into a DC/DC on the secondary side, which is applied to the vehicle electrical system. In this way, the vehicle electrical system is supplied with energy during overhead line mode via the overhead line current collector and the DC/DC converter.

In battery mode, however, the vehicle electrical system is supplied with energy via the battery storage. With voltages from typically 500 V, the battery storage applies a lower DC voltage to the vehicle electrical system compared to overhead line mode. In pure battery mode, comparatively low requirements are therefore placed on the dielectric strength of the vehicle electrical system components.

Nevertheless, it has not yet been possible to use the more cost-effective and lower-voltage components of a pure battery trolley vehicle in a hybrid battery trolley vehicle. This is because a higher DC voltage is applied to the vehicle electrical system in overhead line mode compared to battery mode, so the components must be designed for this higher DC voltage. This requires the use of components with a higher dielectric strength in order to reduce the potential risk to personnel and passengers due to the correspondingly higher fault voltages that drop in the event of an insulation fault between a component and the vehicle chassis as the reference ground.

Alternatively, the DC/DC converter could be dimensioned in such a way that it applies a lower DC voltage to the vehicle electrical system, which corresponds to the DC voltage applied during battery mode. However, for the same power, a reduction in the voltage applied to the vehicle electrical system by the DC/DC converter would mean feeding a higher current into the vehicle electrical system. This higher current would in turn require the use of larger conductor cross-sections in and between the components of the vehicle electrical system, which would be associated with increased material requirements and corresponding costs. The more cost-effective components of a pure battery trolley vehicle cannot be used in this case either. Furthermore, the power loss in all components of the vehicle electrical system would increase proportionally if the current is increased, thus reducing efficiency.

The object of the present invention is therefore to enable the use of cost-effective components of a pure battery trolley vehicle, which are designed for DC voltages in battery mode in terms of their dielectric strength, to operate a hybrid battery trolley vehicle without increasing the potential risk to personnel and passengers.

This object is solved in a method of the type mentioned at the beginning by electrically connecting the DC/DC converter to the vehicle chassis when switching from battery mode to overhead line mode in order to reduce the output voltages of the DC/DC converter applied to the vehicle electrical system.

By electrically connecting the DC/DC converter to the vehicle chassis, the reference ground of the vehicle electrical system is set to a potential that lies between the potentials of the secondary-side connections of the DC/DC converter, via which the DC voltage is applied to the vehicle electrical system. In this way, the output voltages of the DC/DC converter applied to the vehicle electrical system via the secondary-side connections are reduced relative to the reference ground of the vehicle electrical system. In this way, the potential difference between the output voltages applied to the vehicle electrical system, i.e. the total voltage of the DC/DC converter, can still be higher than the DC voltage applied to the vehicle electrical system during battery mode in order to optimise costs and efficiency. The components of the vehicle electrical system are supplied with the total voltage. However, the fault voltage to the reference ground in the vehicle electrical system is reduced so that the components do not have to have a higher dielectric strength. By electrically connecting the DC/DC converter to the vehicle chassis when switching from battery mode to overhead line mode, more cost-effective components with lower dielectric strengths can be used in a pure battery trolley vehicle without increasing the potential risk to personnel and passengers.

It is also advantageous if a central secondary connection of the DC/DC converter is electrically connected to the vehicle chassis when switching from battery mode to overhead line mode. If the DC/DC converter is grounded in the centre via its central secondary connection to the reference ground, a high overall voltage of the DC/DC converter can be maintained. The total voltage of the DC/DC converter can be available to the components of the vehicle electrical system for operation. The terminals connected to the vehicle electrical system can have the same potential difference in terms of magnitude compared to the central connection at the potential of the reference ground, but with opposite signs. The maximum possible fault voltage in the vehicle electrical system can be halved in this way, as the vehicle chassis and therefore the reference ground of the vehicle electrical system is centred between the extremes of the DC voltage applied to the vehicle electrical system by the DC/DC converter during overhead line mode.

With the operating method according to the invention, it is possible to convert a pure battery trolley vehicle into a hybrid battery trolley vehicle without having to replace the components of the vehicle electrical system designed for pure battery mode with expensive, more voltage-resistant components.

In one embodiment of the invention, the DC/DC converter is also operated in battery mode, in particular for feeding recuperated energy back into the overhead line.

In an advantageous embodiment of the invention, the battery storage has one or more accumulators.

Preferably, it is detected whether there is an electrical overhead line connection between the hybrid battery trolley vehicle and an overhead line, in particular via the overhead line current collector. By detecting the electrical overhead line connection, a decision can be made easily, in particular by a control device, during operation of the hybrid battery trolley vehicle as to whether it should be operated in overhead line mode or in battery mode. Depending on the result of the detection, it is possible to switch from battery mode to overhead line mode and from overhead line mode to battery mode.

According to one embodiment of the invention, the hybrid battery trolley vehicle is only operated in overhead line mode if an electrical overhead line connection between the hybrid battery trolley vehicle and an overhead line is detected. If no overhead line connection is detected, so that no energy can be absorbed from the overhead line by the hybrid battery trolley vehicle via the overhead line current collector, in particular the two overhead line current collectors, it can be avoided in this way that the hybrid battery trolley vehicle is operated in overhead line mode without it being possible to supply energy to the hybrid battery trolley vehicle in this operating mode. An unnecessary electrical connection of the DC/DC converter to the vehicle chassis can be prevented in the same way.

In an advantageous embodiment, the electrical connection between the DC/DC converter and the vehicle chassis is automatically interrupted and switched to battery mode if the overhead line connection is interrupted. The automatic switchover to battery mode in the event of an interruption in the electrical overhead line connection can ensure continuous operation of the hybrid battery trolley vehicle. Together with the switchover to battery mode, the electrical connection between the DC/DC converter and the vehicle chassis can be automatically interrupted so that the disconnected electrical connection does not interfere with the operation of the hybrid battery trolley vehicle in battery mode.

It can also be advantageous to monitor whether the DC/DC converter and the vehicle chassis are electrically isolated from each other during battery mode. This additional monitoring of the insulation of the DC/DC converter from the vehicle chassis makes it easy to recognise in battery mode whether the electrical connection between the DC/DC converter and the vehicle chassis is still interrupted. Insulation faults between the DC/DC converter and the vehicle chassis can be easily detected by this monitoring during battery mode.

A further embodiment of the invention provides that in the event of an insulation fault, in particular during battery mode, the DC/DC converter is automatically electrically disconnected from the vehicle chassis and/or the overhead line current collector is automatically electrically disconnected from the DC/DC converter. By automatically disconnecting the electrical connection between the DC/DC converter, in particular the secondary side of the DC/DC converter, and the vehicle chassis and/or the electrical connection between the overhead line current collector and the DC/DC converter, in particular the primary side of the DC/DC converter, effective protective measures can be initiated in the event of an insulation fault. In particular, the insulation fault may be a flowing fault current and/or a lack of or missing electrical insulation of the DC/DC converter from the vehicle chassis during battery mode. In particular, a malfunction when switching from overhead line mode to battery mode, such as a fault when the electrical connection between the DC/DC converter and the vehicle chassis is interrupted, can be rectified by automatically disconnecting the electrical connection.

In order to solve the above-mentioned problem, it is proposed that a hybrid battery trolley vehicle of the type mentioned above has a switching device for establishing an electrical connection between the DC/DC converter and the vehicle chassis depending on the operating mode, in particular for reducing the output voltages of the DC/DC converter applied to the vehicle electrical system during overhead line mode.

The switching device can be used to establish the electrical connection between the DC/DC converter and the vehicle chassis when switching from battery mode to overhead line mode. The reference ground of the vehicle electrical system can therefore be set by the switching device to a potential lying between the potentials of the secondary-side connections of the DC/DC converter, via which the DC/DC can be applied to the vehicle electrical system. In this way, the output voltages of the DC/DC converter applied to the vehicle electrical system via the secondary-side connections can be reduced relative to the reference ground of the vehicle electrical system. In this way, the potential difference between the output voltages applied to the vehicle electrical system, i.e. the total voltage of the DC/DC converter, can be higher than the DC voltage that can be applied to the vehicle electrical system in battery mode in order to optimise costs and efficiency. The components of the vehicle electrical system can be supplied with the total voltage. In this way, the fault voltage to reference ground can be reduced in the vehicle electrical system so that the components of the vehicle electrical system do not have to have a higher dielectric strength. The electrical connection of the DC/DC converter to the vehicle chassis, which can be established by the switching device when switching from battery mode to overhead line mode, means that more cost-effective components of a pure battery trolley vehicle with lower dielectric strengths can be used without increasing the potential risk to personnel and passengers.

The features described in connection with the method according to the invention can also be used individually or in combination in the hybrid battery trolley vehicle. This results in the same advantages that have already been described.

The switching device is preferably connected to the secondary side of the DC/DC converter. In this way, the switching device represents a secondary-side switching device of the hybrid battery trolley vehicle.

According to one constructional embodiment, it is proposed that the switching device has a switching element connected between the DC/DC converter and the vehicle chassis. With the switching element, the switching device can easily establish the electrical connection between the DC/DC converter and the vehicle chassis when switching from battery mode to overhead line mode and interrupt it when switching from overhead line mode to battery mode.

In an advantageous manner, the switching device is connected to a central secondary-side connection of the DC/DC converter. In this way, an electrical connection between this central secondary connection of the DC/DC converter and the vehicle chassis can be established and interrupted by the switching device, in particular its switching element.

Preferably, the vehicle electrical system is galvanically isolated from the overhead line current collector by the DC/DC converter. In this way, the components of the vehicle electrical system are galvanically isolated, in particular double-galvanically isolated, from the overhead line current collector and thus from the overhead line during operation of the hybrid battery trolley vehicle. Such an isolating DC/DC converter is also referred to as an isolating transducer.

In a further embodiment of the invention, the hybrid battery trolley vehicle has a detection device, in particular one that controls the switching device, for detecting an existing electrical overhead line connection with an overhead line. The detection device can be used to easily recognise an existing electrical overhead line connection. The detection device can enable automatic switching from battery mode to overhead line mode as soon as an overhead line connection is detected. Alternatively, or additionally, the detection device can also be used to detect an interruption of a previously existing overhead line connection, in particular to enable automatic switching from overhead line mode to battery mode. In order to be able to establish and/or interrupt the electrical connection between the DC/DC converter and the vehicle chassis during automatic switching from battery mode to overhead line mode and/or automatic switching from overhead line mode to battery mode, the detection device can control the switching device, in particular its switching element. In this way, the switching device can be automatically actuated when an existing or interrupted overhead line connection is detected.

In an advantageous embodiment, the hybrid battery trolley vehicle has an insulation monitoring device for monitoring the electrical insulation of the vehicle electrical system and the vehicle chassis, in particular during battery mode. The insulation monitoring device can be used to easily detect insulation faults in the vehicle electrical system in relation to the vehicle chassis. In particular, the insulation monitoring device can be used to monitor the electrical insulation of the DC/DC converter, especially the secondary side of the DC/DC converter, and the vehicle chassis during battery mode.

In an advantageous embodiment of the invention, the hybrid battery trolley vehicle has a line protection device, in particular comprising a further switching element, between a primary side of the DC/DC converter and the overhead line current collector. The line protection device can be used to provide a redundant option for disconnecting the electrical connection between the DC/DC converter and the overhead line, in addition to disconnecting the overhead line current collector physically from the overhead contact line. The primary side of the DC/DC converter can be disconnected from the overhead line by the switching element of the line protection device, even if the overhead line current collector is still in its wired position. The line protection device can enable the electrical connection between the DC/DC converter and the overhead line to be interrupted more quickly than would be possible if the overhead line current collector were disconnected. In the event of an insulation fault in particular, the line protection device can disconnect the hybrid battery trolley vehicle to protect it, i.e. electrically isolate it from the overhead line.

It is also advantageous if the insulation monitoring device is set up to control the switching device and/or the line protection device when an insulation fault is detected, in particular when an electrical connection between the DC/DC converter and the vehicle chassis is detected during battery mode. With an insulation monitoring device set up in this way, safety measures can be initiated by the control of the switching device and/or the line protection device. When an insulation fault, in particular a fault current, is detected, the insulation monitoring device can be used to interrupt an electrical connection between the DC/DC converter and the vehicle chassis by controlling the switching device and/or the hybrid battery trolley vehicle can be enabled by controlling the line protection device. In battery mode in particular, control of the switching device by the insulation monitoring device can permit fault correction if the electrical connection between the DC/DC converter and the vehicle chassis was not interrupted when switching from overhead line mode to battery mode and the insulation monitoring device therefore recognises this electrical connection.

In accordance with a constructional embodiment of the invention, it is proposed that at least one electric traction drive motor, in particular an asynchronous motor, is provided in the vehicle electrical system. By means of an electric traction drive motor in the vehicle electrical system, the hybrid battery trolley vehicle can be driven by the same motor both in overhead line mode and in battery mode. An asynchronous motor in particular has proven to be an advantageous traction drive motor embodiment in this context.

Further details and advantages of a method according to the invention and of a hybrid battery trolley vehicle according to the invention will be explained below by way of example using an embodiment of the invention shown schematically in the figure. It shows:

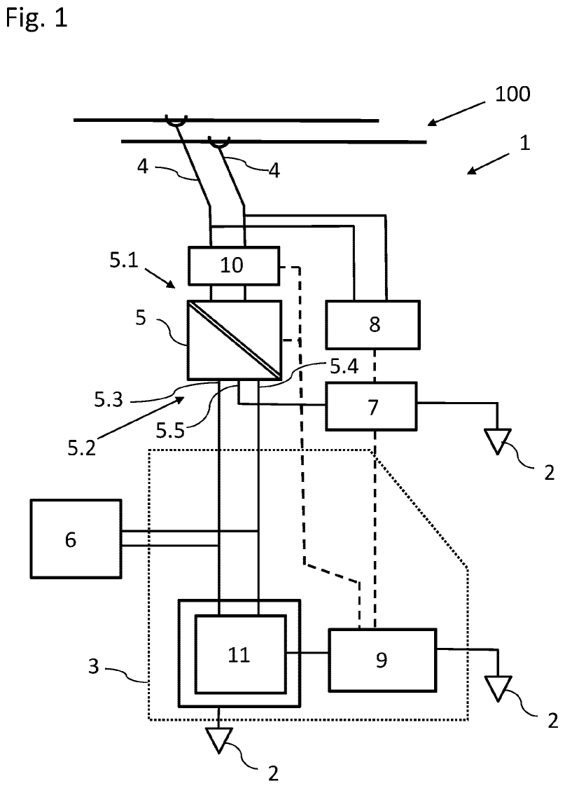

FIG. 1 The schematic structure of a hybrid battery trolley vehicle according to the invention with an existing electrical overhead line connection.

FIG. 1 shows the schematic structure of a hybrid battery trolley vehicle 1 according to the invention, which is electrically connected to an overhead line 100 of an overhead line network. This electrical overhead line connection between the hybrid battery trolley vehicle 1 and the overhead line 100 is established via the two swivelling overhead line current collectors 4 of the hybrid battery trolley vehicle 1. In FIG. 1, these two overhead line current collectors 4 are shown in their wired-on position, in which they are physically in contact with the individual contact wires of the overhead line 100 and in this way establish an electrical connection with the overhead line 100.

In this state, the hybrid battery trolley vehicle 1 is supplied with the energy required for its operation by the overhead line 100. The hybrid battery trolley vehicle 1 is in overhead line operation. In this overhead line mode, the overhead line current collectors 4 connect the overhead line 100 to the primary side 5.1 of a DC/DC converter 5 via a line protection device 10. The DC/DC converter 5 converts the DC voltage provided to the hybrid battery trolley vehicle 1 by the overhead line 100, which is supplied to the primary side 5.1 at the DC/DC converter 5, which is typically 600V to 750V, into a DC voltage which is applied to a vehicle electrical system 3 of the hybrid battery trolley vehicle 1 on the secondary side 5.2 of the DC/DC converter 5. For this purpose, the two secondary-side connections 5.3 and 5.4 of the DC/DC converter 5 are connected to the vehicle electrical system 3. In this way, the total secondary-side voltage of the DC/DC converter 5 corresponding to the potential difference between the secondary-side connections 5.3 and 5.4 is applied to the vehicle electrical system 3 so that the vehicle electrical system 3 is supplied with energy via the overhead line current collectors 4 and the DC/DC converter 5 during overhead line mode. The DC/DC converter 5 is designed as an isolating transducer, which galvanically isolates the vehicle electrical system 3 from the overhead line current collector 4 and thus from the overhead line 100.

Various electrical components 11, such as electrical consumers, are arranged in the vehicle electrical system 3 of the hybrid battery trolley vehicle 1, which are supplied with energy via the vehicle electrical system 3 to operate the hybrid battery trolley vehicle 1. These components 11 can be, for example, exterior and interior lighting, an air conditioning system, a vehicle intercom system or control electronics of the hybrid battery trolley vehicle 1. As a further component 11, the electric traction drive motor of the hybrid battery trolley vehicle 1 is also provided as a consumer in the vehicle electrical system 3, which is also supplied with the energy used to drive the entire hybrid battery trolley vehicle 1.

In addition to the energy supply to the vehicle electrical system 3 via the overhead line current collectors 4 and the DC/DC converter 5, the hybrid battery trolley vehicle 1 also has a battery storage 6, which supplies the vehicle electrical system 3 with energy in battery mode as an alternative energy source to the overhead line 100. The battery storage 6 can consist of one or more accumulators or other capacitive elements in which electrical energy can be temporarily stored and fed into the vehicle electrical system 3 to operate the hybrid battery trolley vehicle 1. The battery storage 6 also allows recuperated energy to be absorbed when the hybrid battery trolley vehicle brakes. In this way, the battery storage 6 enables very energy-efficient operation of the hybrid battery trolley vehicle.

Due to the possibility of being operated both in overhead line mode and in battery mode, the hybrid battery trolley vehicle 1 differs both from a pure trolley vehicle, which is supplied with energy solely via the overhead line 100, and from a pure battery vehicle, which only uses the vehicle battery for its energy supply. The hybrid battery trolley vehicle 1 can therefore combine the advantages of both vehicle types and compensate for their respective disadvantages. Thanks to the battery storage 6, the hybrid battery trolley vehicle 1 can also cover longer distances along which there is no overhead line 100, meaning that a pure trolley vehicle would not be able to travel these distances. As it is possible for the hybrid battery trolley vehicle 1 to be supplied with energy by the overhead line 100 via the overhead line current collectors 4 and the DC/DC converter 5 along sections of the route with overhead lines 100, the energy stored in the battery storage 6 does not have to be used for the entire journey. In fact, it is even possible to charge the battery storage 6 during overhead line mode via the DC/DC converter 5 and the vehicle electrical system 3 so that, in contrast to pure battery vehicles, the number and duration of the stopping phases used for charging can be reduced.

While the battery storage 6 applies a comparatively low voltage to the vehicle electrical system 3 in battery mode, so that the components 11 of the vehicle electrical system 3 only need to have a comparatively low dielectric strength in battery mode, as the residual voltage that drops in the event of an insulation fault between a component and the ungrounded vehicle chassis shown in FIG. 2 is comparatively low, the total secondary voltage of the DC/DC converter 5 applied to the vehicle electrical system 3 between the connections 5.3 and 5.4 during overhead line mode is significantly higher. Typically, this total secondary-side voltage of the DC/DC converter 5 is in the range of 500 V to 850 V. In order to avoid having to use components 11 in the vehicle electrical system 3, which have a significantly higher dielectric strength compared to the requirements of battery mode and are correspondingly more expensive, the hybrid battery trolley vehicle 1 according to the invention has a switching device 7.

This switching device 7 can be used to electrically connect a central secondary-side connection 5.5 of the DC/DC converter 5 to the vehicle chassis 2. This central secondary-side connection 5.5, whose potential lies between the potentials of connection 5.3 and connection 5.4, sets the reference ground of the vehicle electrical system 3 formed by the vehicle chassis 2 to a potential lying between the potentials of the secondary-side connections 5.3, 5.4. In this way, the output voltages of the secondary-side connections 5.3 and 5.4 of the DC/DC converter 5 applied to the vehicle electrical system are reduced relative to the reference ground of the vehicle electrical system 3. The maximum fault voltages occurring in the vehicle electrical system 3 relative to the reference ground of the vehicle chassis 2 are therefore reduced so that components 11 with comparatively low dielectric strength can also be used in overhead line mode.

In particular, if the potential of the central secondary-side connection 5.5 is halfway between the potentials of connections 5.3 and 5.4, the output voltages of the secondary-side connections 5.3 and 5.4 are of the same magnitude with respect to the reference ground and differ only in their signs. If, for example, the potential difference between the secondary-side connections 5.3 and 5.4 is 800 V, the output voltages of the secondary-side connections 5.3 and 5.4 are only +400 V or −400 V relative to the reference ground of the vehicle electrical system 3 due to the electrical connection established between the central secondary-side connection 5.5 and the vehicle chassis 2. The maximum fault voltages occurring in the vehicle electrical system 3 relative to the reference ground of the vehicle chassis 2 are therefore also a maximum of 400 V in terms of magnitude.

In addition to the switching device 7, the hybrid battery trolley vehicle 1 has a detection device 8, which can be used to detect the existence of an electrical overhead line connection. This detection device 8 is connected upstream of the DC/DC converter 5 on its primary side 5.1 and is electrically connected to the overhead line current collectors 4. This enables the detection device 8 to easily detect whether there is an overhead line connection via the overhead line current collectors 4 or whether the overhead line connection to the overhead line 100 has been interrupted.

To ensure that the central secondary-side connection 5.5 of the DC/DC converter 5 is only electrically connected to the vehicle chassis 2 during overhead line mode, as an electrical connection between the DC/DC converter 5 and the vehicle chassis 2 can otherwise lead to faults during battery mode, the detection device 8 is also designed so that it can directly control the switching device 7. In FIG. 1, this control option is indicated by a dashed line. As soon as the detection device 8 detects an interruption in the electrical overhead line connection, it can independently control the switching device 7 and in this way automatically interrupt the electrical connection between the DC/DC converter 5 and the vehicle chassis 2.

In addition to the detection device 8, the hybrid battery trolley vehicle 1 has another monitoring device, the insulation monitoring device 9. The insulation monitoring device 9 is used to monitor whether insulation faults and, in particular, fault currents occur between the components 11 of the vehicle electrical system 3 and the vehicle chassis 2. In order to then enable the hybrid battery trolley vehicle 1 in overhead line mode as a protective measure, i.e. to disconnect it electrically from the overhead line 10 as quickly as possible, the insulation monitoring device 9 can control the line protection device 10. In FIG. 1, the control connections via which the insulation monitoring device 9 can control other devices are also indicated by dashed lines.

The line protection device 10 has switching elements that can interrupt the electrical connection between the overhead line current collectors 4 and the DC/DC converter 5. If the switching elements of the line protection device 10 are actuated, no more energy is transmitted from the overhead line 100 to the DC/DC converter 5 via the overhead line current collectors 4, so that the hybrid battery trolley vehicle 1 is enabled in this respect. The line protection device 10 enables a faster reaction and a correspondingly faster disconnection than would be possible by physically swivelling the overhead line current collectors 4 when disconnecting them from the overhead line 100.

In addition to the general monitoring of the insulation of the components 11 of the vehicle electrical system 3, the insulation monitoring device 9 is also used in battery mode to monitor the insulation of the secondary side 5.2 of the DC/DC converter 5 from the vehicle chassis 2. If the insulation monitoring device 9 detects that there is still an electrical connection between the DC/DC converter 5 and the vehicle chassis 2 in battery mode, for example because an error has occurred during the control of the switching device 7 by the detection device 8, the insulation monitoring device 9 can also control the switching device 7. In this way, it is possible for the insulation monitoring device 9 to rectify a fault when switching from overhead line mode to battery mode, during which the electrical connection between the DC/DC converter 5 and the vehicle chassis 2 should also be automatically interrupted. The insulation monitoring device 9 can therefore be used to ensure that an electrical connection between the connection 5.5 of the DC/DC converter 5 and the vehicle chassis 2 only exists during overhead line mode.

With the aid of the method described above and the hybrid battery trolley vehicle 1 according to the invention, it is possible to enable components 11 designed for DC voltages in battery mode, in particular components 11 of a pure battery trolley vehicle, to operate the hybrid battery trolley vehicle 1 in a cost-effective manner without increasing the hazard potential for personnel and passengers.

### LIST OF REFERENCE SYMBOLS

1 Hybrid battery trolley vehicle
2 Vehicle chassis
3 Electrical vehicle system
4 Overhead line current collector
5 DC/DC converter
5.1 Primary side
5.2 Secondary side
5.3 Secondary connection
5.4 Secondary connection
5.5 Secondary connection
6 Battery storage
7 Switching device
8 Detection device
9 Insulation monitoring device
10 Line protection device
11 Components
100 Overhead line

1. Method for operating a hybrid battery trolley vehicle (1), which has an ungrounded vehicle chassis (2), a vehicle electrical system (3), an overhead line current collector (4), a DC/DC converter (5) and a battery storage (6), comprising, switching between an overhead line mode, in which the vehicle electrical system (3) is supplied with energy via the overhead line current collector (4) and the DC/DC converter (5), and a battery mode, in which the vehicle electrical system (3) is supplied with energy via the battery storage (6), wherein when switching from battery mode to overhead line mode, the DC/DC converter (5) is electrically connected to the vehicle chassis (2) to reduce the output voltages of the DC/DC converter (5) present on the vehicle electrical system (3).

2. Method according to claim 1, wherein
when switching from battery mode to overhead line mode, a central secondary-side connection (5.5) of the DC/DC converter (5) is electrically connected to the vehicle chassis (2).

3. Method according to claim 1, further comprising detecting
whether there is an electrical overhead line connection between the hybrid battery trolley vehicle (1) and an overhead line (100), in particular via the overhead line current collector (4).

4. Method according to claim 1, wherein
the hybrid battery trolley vehicle (1) is only operated in overhead line mode if an electrical overhead line connection between the hybrid battery trolley vehicle (1) and an overhead line (100) is detected.

5. Method according to claim 1, further comprising automatically interrupting the electrical connection between the DC/DC converter (5) and the ungrounded vehicle chassis (2) and switching to the battery mode if the overhead line connection is interrupted.

6. Method according to claim 1, further comprising
in battery mode, monitoring whether the DC/DC converter (5) and the vehicle chassis (2) are electrically isolated from each other.

7. Method according to claim 1, further comprising
in the event of an insulation fault, in battery mode, automatically electrically disconnecting the DC/DC converter (5) from the vehicle chassis (2) and/or automatically electrically disconnecting the overhead line current collector (4) from the DC/DC converter (5).

8. Hybrid battery trolley vehicle, comprising:
an ungrounded vehicle chassis (2);
a vehicle electrical system (3);
an overhead line current collector (4);
a DC/DC converter (5);
wherein the DC/DC converter (5) is configured for supplying energy to the vehicle electrical system (3) in an overhead line mode and a battery storage (6) for supplying energy to the vehicle electrical system (3) in a battery mode;
a switching device (7) for establishing an operating mode depending electrical connection between the DC/DC converter (5) and the vehicle chassis (2), in particular for reducing the output voltages of the DC/DC converter (5) present at the vehicle electrical system (3) during overhead line mode.

9. Hybrid battery trolley vehicle according to claim 8, wherein
the switching device (7) has a switching element connected between the DC/DC converter (5) and the vehicle chassis (2).

10. Hybrid battery trolley vehicle according to claim 8, wherein
the vehicle electrical system (3) is galvanically isolated from the overhead line current collector (4) by the DC/DC converter (5).

11. Hybrid battery trolley vehicle according to claim 8, further comprising
a detection device (8), in particular controlling the switching device (7), for detecting an existing electrical overhead line connection with an overhead line (100).

12. Hybrid battery trolley vehicle according to claim 8, further comprising
an insulation monitoring device (9) for monitoring the electrical insulation of the vehicle electrical system (3) and the vehicle chassis (2), in particular in battery mode.

13. Hybrid battery trolley vehicle according to claim 8, wherein
a line protection device (10), in particular having a further switching element, between a primary side (5.1) of the DC/DC converter (5) and the overhead line current collector (4).

14. Hybrid battery trolley vehicle according to claim 8, wherein
the insulation monitoring device (9) is configured to control the switching device (7) and/or the line protection device (10) when an insulation fault is detected, in particular when an electrical connection between the DC/DC converter (5) and the vehicle chassis (2) in battery mode is detected.

15. Hybrid battery trolley vehicle according to claim 8, further comprising
at least one electric traction drive motor (11), in particular an asynchronous motor, is provided in the vehicle electrical system (3).

16. Hybrid battery trolley vehicle according to claim 8, wherein the switching device (7) has a switching element connected between the DC/DC converter (5) and the vehicle chassis (2); and
wherein the vehicle electrical system (3) is galvanically isolated from the overhead line current collector (4) by the DC/DC converter (5).

17. Hybrid battery trolley vehicle according to claim 8: further comprising:
a detection device (8), in particular controlling the switching device (7), for detecting an existing electrical overhead line connection with an overhead line (100);
an insulation monitoring device (9) for monitoring the electrical insulation of the vehicle electrical system (3) and the vehicle chassis (2), in particular in battery mode;
wherein the switching device (7) has a switching element connected between the DC/DC converter (5) and the vehicle chassis (2);
wherein the vehicle electrical system (3) is galvanically isolated from the overhead line current collector (4) by the DC/DC converter (5).

18. Hybrid battery trolley vehicle according to claim 8: further comprising:
a detection device (8), in particular controlling the switching device (7), for detecting an existing electrical overhead line connection with an overhead line (100);
an insulation monitoring device (9) for monitoring the electrical insulation of the vehicle electrical system (3) and the vehicle chassis (2), in particular in battery mode;
a line protection device (10), in particular having a further switching element, between a primary side (5.1) of the DC/DC converter (5) and the overhead line current collector (4);
wherein the switching device (7) has a switching element connected between the DC/DC converter (5) and the vehicle chassis (2);
wherein the vehicle electrical system (3) is galvanically isolated from the overhead line current collector (4) by the DC/DC converter (5).

19. Hybrid battery trolley vehicle according to claim 8: further comprising:
a detection device (8), in particular controlling the switching device (7), for detecting an existing electrical overhead line connection with an overhead line (100);
an insulation monitoring device (9) for monitoring the electrical insulation of the vehicle electrical system (3) and the vehicle chassis (2), in particular in battery mode;
at least one electric traction drive motor (11), in particular an asynchronous motor, is provided in the vehicle electrical system (3); and
wherein the insulation monitoring device (9) is configured to control the switching device (7) and/or the line protection device (10) when an insulation fault is detected, in particular when an electrical connection between the DC/DC converter (5) and the vehicle chassis (2) in battery mode is detected;
a line protection device (10), in particular having a further switching element, between a primary side (5.1) of the DC/DC converter (5) and the overhead line current collector (4);
wherein the switching device (7) has a switching element connected between the DC/DC converter (5) and the vehicle chassis (2);
wherein the vehicle electrical system (3) is galvanically isolated from the overhead line current collector (4) by the DC/DC converter (5).

20. Hybrid battery trolley vehicle according to claim 8: further comprising:
a detection device (8), in particular controlling the switching device (7), for detecting an existing electrical overhead line connection with an overhead line (100);
an insulation monitoring device (9) for monitoring the electrical insulation of the vehicle electrical system (3) and the vehicle chassis (2), in particular in battery mode;
at least one electric traction drive motor (11), in particular an asynchronous motor, is provided in the vehicle electrical system (3); and
wherein the insulation monitoring device (9) is configured to control the switching device (7) and/or the line protection device (10) when an insulation fault is detected, in particular when an electrical connection between the DC/DC converter (5) and the vehicle chassis (2) in battery mode is detected;
a line protection device (10), in particular having a further switching element, between a primary side (5.1) of the DC/DC converter (5) and the overhead line current collector (4);
at least one electric traction drive motor (11), in particular an asynchronous motor, is provided in the vehicle electrical system (3);
wherein the switching device (7) has a switching element connected between the DC/DC converter (5) and the vehicle chassis (2);
wherein the vehicle electrical system (3) is galvanically isolated from the overhead line current collector (4) by the DC/DC converter (5).
